(19) United States
(12) Patent Application Publication
(10) Pub. No.: US 2017/0339908 A1
(43) Pub. Date: Nov. 30, 2017

(54) CURD-DRAINING MACHINE

(71) Applicant: CMT COSTRUZIONI MECCANICHE E TECNOLOGIA SPA, Peveragno (IT)

(72) Inventor: Stefano TOMATIS, Peveragno (IT)

(73) Assignee: CMT COSTRUZIONI MECCANICHE E TECNOLOGIA SPA, Peveragno (IT)

(21) Appl. No.: 15/520,943

(22) PCT Filed: Oct. 16, 2015
(86) PCT No.: PCT/EP2015/073993

§ 371 Date: Apr. 21, 2017

(30) Foreign Application Priority Data
Oct. 24, 2014 (IT) TO2014A000867

(51) Int. Cl. A01J 25/11

(52) U.S. Cl. CPC A01J 25/111; A01J 25/118

(57) ABSTRACT

A channel, which is slanted upwardly from a loading end thereof to an unloading end thereof by an angle in the range of 10° to 45°, accommodates a motorized screw feeder; a settling tank, defined above the loading end of the channel, has at least two areas which are separated by at least one filtering surface which is permeable to whey; a first area is adapted to receive curd to be drained, and is open toward the channel so that the curd can fall into the channel by gravity and be conveyed by the screw feeder toward the unloading end; the second area is adapted to receive the whey filtered through the filtering wall.

The present invention relates to a curd-draining machine.

As is known, curd is obtained by adding rennet to heated milk, so as to cause the coagulation of the particles of casein until a gelatinous mass is formed, inside which bubbles of whey remain trapped.

In industrial production, it is known to coagulate milk in vats which are usually provided with a rotating curd-cutter which breaks up the coagulated mass and frees the whey trapped inside. Once the first whey is removed, the curd is usually transferred to a draining apparatus so as to remove the whey that is still present.

A conventional draining system uses a long, motorized and microperforated belt, which slowly conveys the curd to the stretching stations. During the trip, which can typically last a few hours, the whey is drained through the holes on the belt and, simultaneously, the curd ripens until it reaches the desired pH level for subsequent stretching operations.

Belt drainers of the type described above suffer the drawback that the smaller solid particles of curd can easily fall through the holes in the belt, with loss of product and consequent reduction in yield, or they can block the holes, with progressive reduction of the draining capacity and need for frequent cleaning operations.

That notwithstanding, since they also have to act as ripeners, belt drainers also need to be very long in order to absorb the entire production of curd and allow it to ripen for the necessary hours. Such fact not only entails a high space occupation, it also ensures that the washing operations are also very wasteful in terms of time and consumption of hot water, due to the extensive surfaces to be washed, with consequent further drawbacks in terms of production costs. Furthermore, given the great masses to be shifted, belt drainers/ripeners require a great deal of energy for their operation.

Another type of conventional drainer comprises a rotary microperforated drum with a horizontal axis, on which the curd is made to advance for a portion corresponding to a certain arc of rotation of the drum. By passing over the drum, the whey is drained into the drum through the holes.

Drum drainers are also known which operate in reverse with respect to the previous description, i.e., the curd to be drained is placed inside the drum and the whey is drained outward.

The above mentioned rotary drum drainers suffer the same drawback as the belt drainers of the type described above, with regard to the risk that the smaller solid particles of curd can be evacuated together with the whey, or they can block the perforations on the drum.

The aim of the present invention is therefore to provide a curd-draining machine that overcomes the drawbacks of conventional draining systems such as those mentioned above, and which has a relatively compact structure, a greater yield, with the capacity to retain even the smallest solid particles, and greater efficiency with regard to the risk that such smaller solid particles can block the surface through which the whey is drained.

The above aims and other advantages, which will become evident from the description that follows, are achieved by the curd-draining machine having the characteristics recited in the appended claim 1, while the appended dependent claims define other characteristics of the invention which are advantageous, although secondary.

The machine according to the invention will be described in more detail, with reference to some preferred, but not exclusive, embodiments thereof, which are illustrated for the purposes of non-limiting example in the accompanying drawings, wherein:

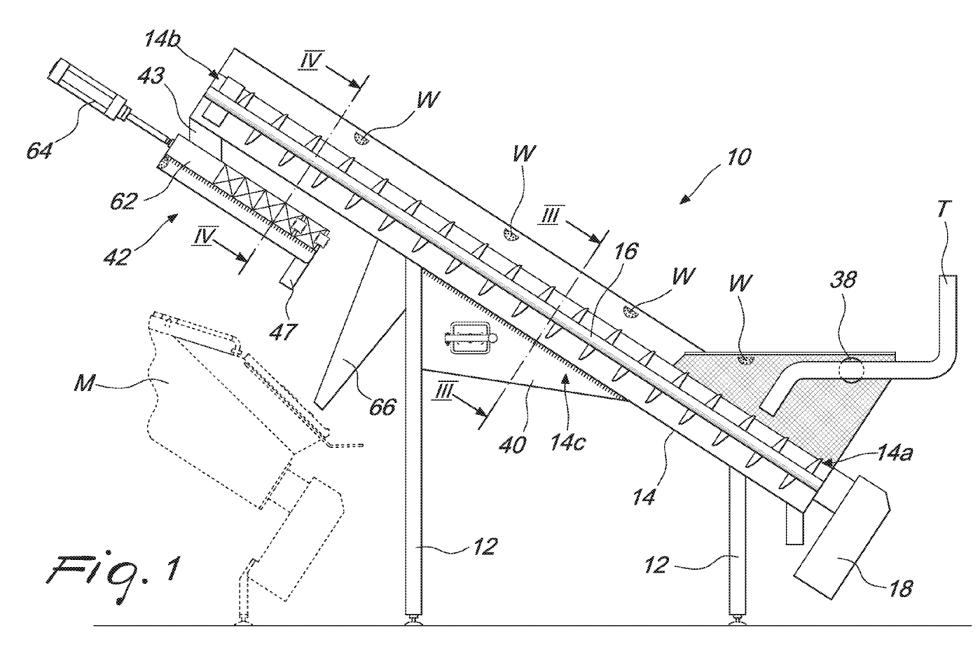

FIG. 1 is a longitudinal cross-sectional view of the machine according to the invention;

FIG. 2 is a perspective view showing a portion of the machine in FIG. 1;

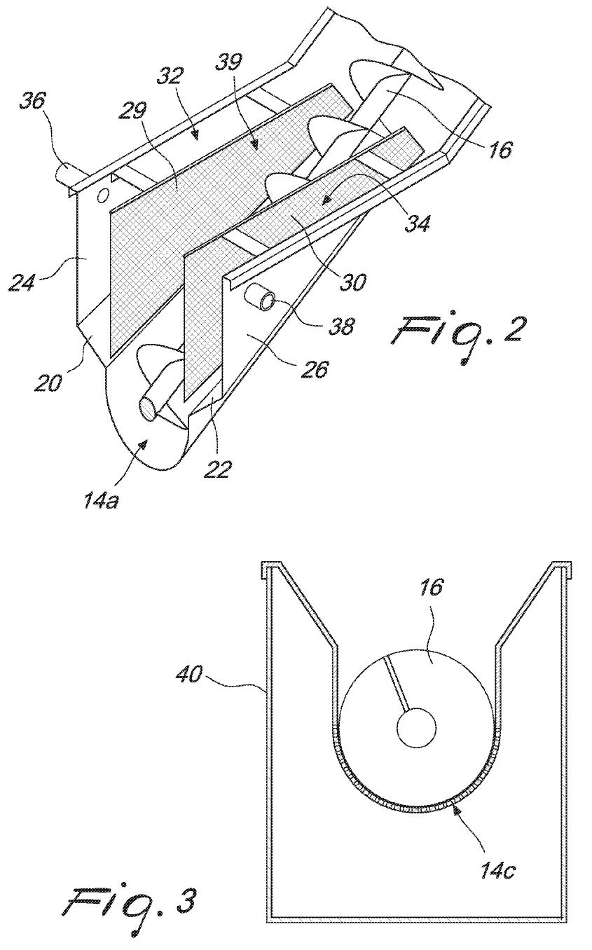

FIG. 3 is a cross-sectional view of FIG. 1 taken along the line III-III;

FIG. 4 is a cross-sectional view of FIG. 1 taken along the line IV-IV;

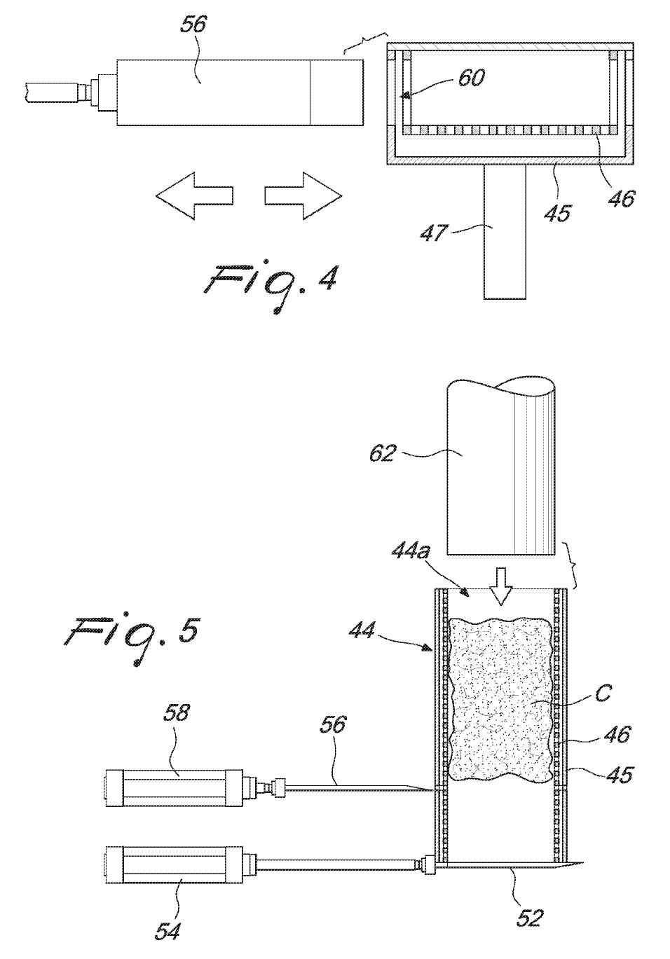

FIG. 5 is a cross-sectional view of FIG. 4;

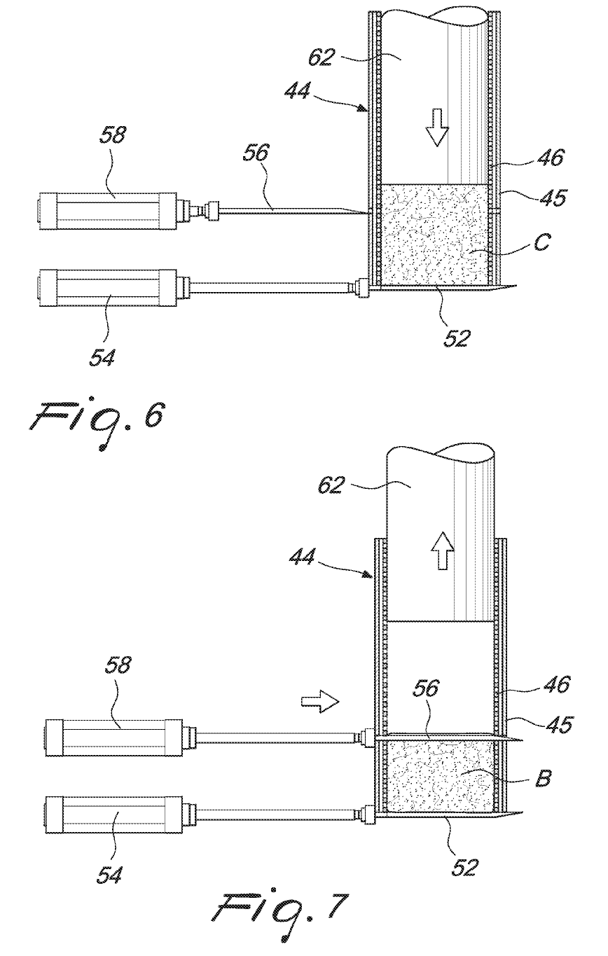

FIGS. 6-9 are similar views to FIG. 5, and show the machine in four successive steps of operation.

With reference to the figures, a curd-draining machine 10 according to the invention comprises a frame 12 which supports a channel 14 which is slanted upwardly from a loading end 14a thereof to an unloading end 14b thereof, by an angle in the range of 10° to 45°, advantageously approximately 33° in the example shown. The channel 14 has a circular arc-shaped internal profile, and accommodates a screw feeder 16 which is turned by a gearmotor 18 fixed to the loading end 14a of the channel 14. The channel 14 has a settling area at its loading end 14a, in which the upper edges of the channel 14 widen out first into two connecting bands 20, 22 which diverge upwardly, and then into two vertical walls 24, 26 which are mutually parallel, so as to define a settling tank 28. The upper edges of the vertical walls 24, 26 extend horizontally until they meet the upper edges of the connecting bands 20, 22. Inside the settling tank 28 two filtering walls 29, 30, which are permeable to whey, extend parallel to the vertical walls 24, 26 and spaced apart from them so as to define respective lateral interspaces 32, 34. The latter are adapted to receive the whey filtered through the filtering walls 29, 30, as will be described in more detail hereinafter. Preferably, the two filtering walls 29, 30 are constituted by a thin-mesh, micro-perforated tissue, for example, with a mesh size comprised between 0.2 and 2.5 mm. Alternatively, the filtering walls can be constituted by a fine-mesh metallic net. Each one of the vertical walls 24, 26 is provided with an overflow outlet 36, 38 which is arranged proximate to the upper edge 24a, 26a of the respective wall, for the excess whey to be drained off. The curd to be drained is poured into the settling tank 28, in the area 39 delimited between the filtering walls 29, 30, from a generic tube T (FIG. 1) which is outside the scope of the present invention. The channel is further provided with a number of washing heads W.

Downstream of the settling area, the channel 14 is advantageously provided with a perforated intermediate portion 14c, with holes of diameter comprised preferably between 0.2 and 2.5 mm, underneath which there is a collection chamber 40 into which the whey still present in the curd can drain by gravity (FIG. 3). The dimensions of the holes in FIG. 3 have been accentuated for clarity of illustration.

Finally, the channel 14 unloads the curd into a squeezing device 42, by way of an unloading outlet 43 which is arranged at the unloading end 14b of the channel 14.

With reference to FIGS. 4 and 5, the squeezing device 42 comprises a squeezing chamber in the form of a duct 44 with a rectangular cross-section, delimited below and laterally by a double wall with an interspace, and above by a single wall. The outer wall 45 of the interspace is continuous, while the inner wall 46 is perforated and is advantageously constituted by a fine-mesh metallic net, with a mesh size preferably comprised between 0.2 and 2.5 mm. The dimensions of the holes in the figures have been accentuated for clarity of illustration. The interspace discharges into the atmosphere through a discharging outlet 47 defined in the bottom of the duct 44.

The duct 44 is inclined downwardly from an inlet end 44a thereof, which is connected to the unloading outlet 43, to an outlet end 44b thereof, advantageously with the same inclination as the channel 14. A first blade 52 can move transversely with respect to the duct 44 in a position aligned with the outlet end 44b upon the command of a first pneumatic actuator 54, between a retracted, open position in which it does not obstruct the outlet end 44b, and an extended, closed position in which it obstructs it completely. A second blade 56 can move transversely with respect to the duct 44 upon the command of a second pneumatic actuator 58, between a retracted position of non-interference and an extended, cutting position in which it is inserted in the duct 44 through a lateral slit 60 which passes through the outer wall 45 and the inner wall 46.

A piston 62, which is actuated by a pneumatic cylinder 64, is slideably inserted inside the duct 44 through its inlet end 44a.

A chute 66 is fixed to the channel 14 in front of the outlet end 44b of the duct 44 in order to redirect the unloaded material toward a machine which is downstream, for example, a stretching machine M, which is outside the scope of the present invention (FIG. 1).

Operation of the machine 10 is advantageously automatically controlled by a controller (not shown), the programming of which forms part of the general knowledge of the person skilled in the art and therefore will not be discussed further.

Operation of the machine 10 will now be described.

The curd mixed with whey is poured into the settling tank 28, between the filtering walls 29, 30, from the tube T. The whey passes through the filtering walls 29, 30 and can fill the tank up to the level of the overflow openings 36, 38. Then the curd, which is held between the filtering walls 29, 30, is deposited in the channel 14 by gravity, since it has a greater specific weight than the whey. Even the smallest solid particles are slowly deposited on the bottom of the settling tank. In fact, the counter-pressure exerted by the whey contained in the interspaces 32, 34 ensures that such particles are not subjected to a difference of pressure which is such as to force them to pass through the filtering walls 29, 30, as happens in conventional draining systems in which what is beyond the filtering surface is the atmosphere.

The curd that has been deposited in the channel 14 at its inlet end 14a, and from which much of the whey has already been extracted, is conveyed to the outlet end 14b by the screw feeder 16. By passing through the perforated intermediate portion 14c, some of the whey still present can drain by gravity into the collection chamber 40. It should be noted that, in this step, the amount of whey has already been drastically reduced, so that the particles of curd that might be evacuated together with the whey, or which might block the holes in the intermediate portion 14c, constitute a negligible amount.

Finally, the curd is unloaded into the squeezing device 42, which operates as follows (FIGS. 5-9).

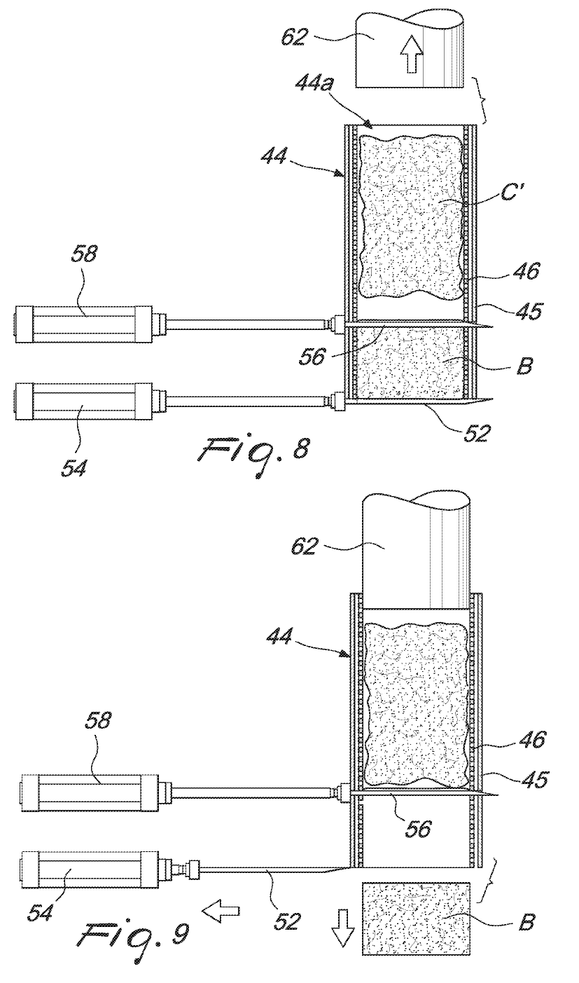

Initially, the piston 62 is in a withdrawn position in which it does not block the unloading outlet 43, so that the curd C unloaded from the channel 14 can fill the duct 44; furthermore, the first blade 52 is in the closed position while the second blade 56 is in the retracted position (FIG. 5). Thereafter, the piston is actuated so as to press the curd, with the residual whey being expelled through the perforated wall 46 that internally delimits the interspace of the duct 44 (FIG. 6). At this point, the second blade 56 is inserted in the duct 44 through the lateral slit 60 so as to cut a block B of curd, and the piston 62 is returned to the initial position (FIG. 7) so as to allow the arrival of new curd C′ from the channel 14 (FIG. 8). Therefore, the first blade 52 is brought to the open position, and the block B of curd that has just been cut falls into the stretching machine M by gravity, guided by the chute 66 (FIG. 9). Once the blades have been returned to their initial positions, the cycle repeats. Advantageously, the pneumatic cylinder 64 is driven so as to arrest the advancement of the piston 62 once a preset pressure has been reached, so as to ensure a uniform level of drying during the process.

As the person skilled in the art will be able to appreciate, the machine 10 according to the invention fully achieves the set aims.

In particular, the machine has a relatively compact structure, especially compared to belt drainers, with many possibilities for adjustment, for example, by acting on the speed of the screw feeder 16, on the pressure exerted by the piston 62, on the inclination of the channel 14, etc.

Furthermore, it has been described how the draining system according to the invention makes it possible to reduce the loss of material to the minimum, with consequent increase in yield, and drastically reduce problems of blocking the filtering walls, with consequent reduction of maintenance operations.

A preferred embodiment of the invention has been described, but obviously the person skilled in the art may make various modifications and variations within the scope of protection of the appended claims. For example, the arrangement and/or the number of filtering surfaces in the settling tank 28 can easily be varied, as long as they are arranged so as to divide the settling tank 28 into at least two areas; for example, there can be a lateral interspace on only one side, or a transverse filtering wall which lies between the rear edges of the filtering walls and defines, with the bottom wall of the channel, a transverse interspace that connects the lateral interspaces. Furthermore, the channel 14 can also accommodate two or more laterally adjacent screw feeders. In addition, for certain applications in which, for example, a curd is required with a greater degree of humidity, the perforated intermediate portion and/or the squeezing device could be removed.

The disclosures in Italian Patent Application No. TO2014A000867 (102014902303994) from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-10. (canceled)

11. A curd-draining machine, comprising:
a channel slanted upwardly from a loading end thereof to an unloading end thereof by an angle in the range of 10° to 45°,
at least one motorized screw feeder which is operatively received in the channel, and
a settling tank defined above the loading end of said channel and having at least two areas separated by at least one filtering surface which is permeable to whey, a first one of said at least two areas, which is adapted to receive curd to be drained, being open toward said channel so that the curd can fall into the channel by gravity and be conveyed by said screw feeder toward said unloading end, a second one of said at least two areas being adapted to receive whey filtered through said at least one filtering surface.

12. The machine according to claim 11, wherein said angle is substantially equal to 33°.

13. The machine according to claim 11, further comprising two of said filtering surfaces which extend substantially parallel to, and spaced apart from, two mutually opposite walls of said settling tank, to define respective interspaces which are adapted to receive the filtered whey.

14. The machine according to claim 11, wherein the second one of said at least two areas is provided with at least one overflow outlet for the excess whey.

15. The machine according to claim 11, wherein said at least one filtering surface is made of a thin-mesh, micro-perforated tissue.

16. The machine according to claim 15, wherein said thin-mesh, micro-perforated tissue has a mesh size in the range of 0.2 to 2.5 mm.

17. The machine according to claim 11, wherein said channel has a perforated intermediate portion downstream of said settling tank, through which the whey in the curd can drain by gravity.

18. The machine according to claim 11, further comprising a squeezing device which is provided with:
a squeezing chamber connected to receive curd from said unloading end of the channel and having at least one perforated wall,
automatically operated closing means associated with an outlet opening of said squeezing chamber, which are movable between an open position, in which they do not obstruct said outlet opening, and a closed position in which they obstruct it, and conversely,
a motorized piston which is slideably insertable into said squeezing chamber through an inlet opening thereof, with said closing means in their closed position, in order to squeeze the curd with drainage of whey through said perforated wall,
an automatically operated blade, which is insertable through said squeezing chamber after squeezing by said piston in order to cut a block of squeezed curd, which is adapted to be discharged through said outlet opening with said closing means in their open position.

19. The machine according to claim 18, wherein said squeezing chamber is slanted downwardly from said inlet opening to said outlet opening in order to discharge said block of squeezed curd by gravity.

20. The machine according to claim 18, wherein said squeezing chamber consists of a duct which is delimited at least partially by a double wall with an interspace, said interspace being internally delimited by said perforated wall and being provided with a discharging outlet.
